(19) United States
(12) Patent Application Publication
(10) Pub. No.: US 2020/0348743 A1
(43) Pub. Date: Nov. 5, 2020

(54) EXECUTION OF TASKS IN INTEGRATED CIRCUITS

(71) Applicant: Nordic Semiconductor ASA, Trondheim (NO)

(72) Inventor: Ville MERIÖ, Trondheim (NO)

(73) Assignee: Nordic Semiconductor ASA, Trondheim (NO)

(21) Appl. No.: 16/762,468

(22) PCT Filed: Nov. 12, 2018
(86) PCT No.: PCT/GB2018/053261

§ 371 Date: May 7, 2020

(30) Foreign Application Priority Data
Nov. 10, 2017 (GB) 1718630.5

(51) Int. Cl. G06F 1/329; G06F 9/48

(52) U.S. Cl. CPC G06F 1/329; G06F 9/4893

(57) ABSTRACT

A method of operating an integrated circuit system is provided. The integrated circuit system comprises a processor operable in at least a lower power state and a higher power state and a memory comprising instructions for executing a first task using the processor. The first task has a minimum execution interval associated therewith. The method comprises executing the first task using the processor and after the minimum execution interval has elapsed, determining whether the processor is in the higher power state. If the processor is in the higher power state after the minimum execution interval elapses, the method further comprises executing the first task using the processor and if the processor is not in the higher power state after the minimum execution interval elapses, the method further comprises not executing the first task.

This invention relates to the execution of scheduled tasks within integrated circuit systems.

Integrated circuit systems, for example System-on-Chips (SoCs), typically comprise a processor along with other components, wherein the processor executes various tasks related to the on-going operation of the system. Often the processor is required to execute certain tasks periodically as part of normal operation. For example, a modem within a radio communications device may have to periodically communicate with a Subscriber Identity Module (SIM) card as part of network authentication, or periodically initiate discontinuous reception (DRX) cycles.

In many integrated circuit systems, particularly those designed for battery operation, the processor is capable of entering into a lower power sleep mode when it is not actively executing processes or tasks in which, for example, high frequency oscillators such as crystals are disabled in order to save power. When required to execute a task the processor “wakes” from the sleep mode. In systems with many periodic tasks that have different periods associated with them, this often means that the processor is woken regularly, to execute each of the tasks. The transition from sleep to awake modes is not instantaneous, and it can take many clock cycles before the processor is ready to execute a task. Accordingly the processor has a wake up time during which the processor's power use is greater than in the sleep mode but it is not actively executing a task, and therefore each wake event for a periodic task has an associated energy cost beyond that required simply to execute the task.

In applications where energy efficiency is of high importance, such as in battery powered devices where long battery life is important, the Applicant has appreciated that it is desirable to minimise the number of wake events to reduce energy use.

The present invention seeks to address the issue outlined above.

From a first aspect, the invention provides a method of operating an integrated circuit system comprising:
a processor operable in at least a lower power state and a higher power state;
a memory comprising instructions for executing a first task using the processor, the first task having a minimum execution interval associated therewith;

wherein the method comprises:
executing the first task using the processor;
after the minimum execution interval has elapsed, determining whether the processor is in the higher power state;
if the processor is in the higher power state after the minimum execution interval elapses, executing the first task using the processor; and
if the processor is not in the higher power state after the minimum execution interval elapses, not executing the first task.

The invention extends to an integrated circuit system comprising:
a processor operable in at least a lower power state and a higher power state;
a memory comprising instructions for executing a first task using the processor, the first task having a minimum execution interval associated therewith;

wherein the integrated circuit system is configured to:
execute the first task using the processor;
after the minimum execution interval has elapsed, determine whether the processor is in the higher power state;
if the processor is in the higher power state after the minimum execution interval elapses, execute the first task using the processor; and
if the processor is not in the higher power state after the minimum execution interval elapses, not execute the first task.

Thus it will be seen by those skilled in the art that, in accordance with the invention, by only executing a task when the processor is already in a higher power state, fewer wake events are performed, reducing energy use. An interrupt is not issued for the execution of the first task, but rather it waits for a suitable opportunity to execute, when the processor is already in the higher power state for some other reason, for example due to an interrupt issued for another task.

Some periodic tasks within integrated circuit systems require execution at very precise intervals. For example DRX operation can significantly reduce the power demands of a radio communications device by utilising periodic DRX cycles, wherein the device receives data only in a short burst at the start of each DRX cycle, such that the device is only active (and using power) for a fraction of each DRX cycle. However, to achieve correct operation, these cycles must be highly synchronised with other network elements and so precise timing is critical.

On the other hand, some tasks have more relaxed execution interval requirements, but still require approximately regular execution to ensure correct on-going operation. For example, a modem may be required to poll a SIM card to verify its presence and identity for network authentication roughly every 30 s, but executing the poll task at, for example, 35 s is acceptable and does not negatively impact upon the modem's functionality. While in embodiments of the invention there may be a degree of imprecision in the execution of a periodic task (i.e. the first task may not be precisely regularly executed), as highlighted above it is acceptable for some tasks to be periodically executed imprecisely, and taking advantage of this may reduce power consumption.

In addition, the Applicant has appreciated that in accordance with the invention, the risk of delaying the execution of another, possibly higher priority, task may be reduced. In prior art systems, should two periodic tasks “timeout” (i.e. require execution while the processor is in a sleep state) at very similar times, the execution of the first task could delay the execution of the second. However in an integrated circuit operated according to embodiments of the present invention, a given task is only executed when the processor is in the higher power state, and so interrupt signals sent by other tasks to the processor while it is in the lower power state are not pre-empted by the first task. The likelihood of the execution of other tasks being delayed is therefore reduced. In some embodiments an imprecise task (e.g. the first task) may only be executed when the processor is in an idle state. An imprecise task (e.g. the first task) may be triggered from an idle task e.g. a lowest priority operating system (OS) task.

In some embodiments the minimum execution interval is measured from the previous execution of the task. In other embodiments the minimum execution interval is measured from a nominal execution time for the task. In the latter case, an overall average frequency of execution can be maintained even though the actual interval between executions will typically vary.

The processor may enter into the lower power state immediately after executing the first task, although alternatively the processor could remain in the higher power state after executing the first task, e.g. to execute one or more further tasks after executing the first task, and enter into the lower power state after the one or more further tasks have been executed.

Operation according to the invention may result in the first task being performed at irregular intervals, but as highlighted above, the Applicant has appreciated that it is acceptable for some kinds of tasks to be executed in this manner. In some embodiments, therefore, an imprecise task (e.g. the first task) may not have a maximum execution interval associated therewith. In some embodiments for example there will be enough strictly periodic tasks that the lower precision tasks will be executed before too long (i.e. without requiring any maximum execution interval).

In typical integrated circuit systems there may be many different tasks that require execution at different intervals. Some of these tasks require precisely periodic execution, whereby they are executed at regular, precise intervals. As such, in some embodiments the memory comprises instructions for a second task that is executed periodically by the processor.

Synchronising the execution of imprecisely periodic tasks with that of precisely periodic tasks is a convenient way to reduce the number of wake events experienced by the system.

Some integrated circuit systems comprise a plurality of periodic and one-off tasks with differing priorities. Accordingly, in some embodiments the memory comprises instructions for a plurality of tasks, each with an associated priority level. Preferably each of the plurality of tasks has an associated minimum execution interval, and in some such embodiments the method comprises:
executing the plurality of tasks using the processor at a respective plurality of execution times;
after the executed tasks' associated minimum execution intervals have elapsed from their respective execution times, determining whether the processor is in the higher power state;
if the processor is in the higher power state after the minimum execution intervals of a subset of the plurality of tasks have elapsed, executing the subset of the plurality of tasks in an order according to their respective associated priority level.

This may ensure that higher priority tasks due to be executed at the same time as lower priority tasks are executed before lower priority tasks, while not waking the processor specifically to execute them.

Some processors are operable in a plurality of power states, and in some circuit systems different tasks are executable by the processor whilst it is in different power states. Consequently, in some embodiments the processor is also operable in a medium power state. In some such embodiments the memory comprises instructions for executing a further task using the processor. Preferably a further minimum execution interval is associated with the further task, and the further task is executable when the processor is in either the medium power state or the higher power state. In some such embodiments the method comprises:
executing the further task using the processor;
after the further minimum execution interval has elapsed, determining whether the processor is in the lower power state, medium power state or higher power state;
if the processor is in the medium or higher power state after the minimum execution interval elapses, executing the further task using the processor; and
if the processor is in the lower power state after the minimum execution interval elapses, not executing the further task.

Features of any aspect or embodiment described herein may, wherever appropriate, be applied to any other aspect or embodiment described herein. Where reference is made to different embodiments or sets of embodiments, it should be understood that these are not necessarily distinct but may overlap.

Certain preferred embodiments of the invention will now be described, by way of example only, with reference to the accompanying drawings, in which:

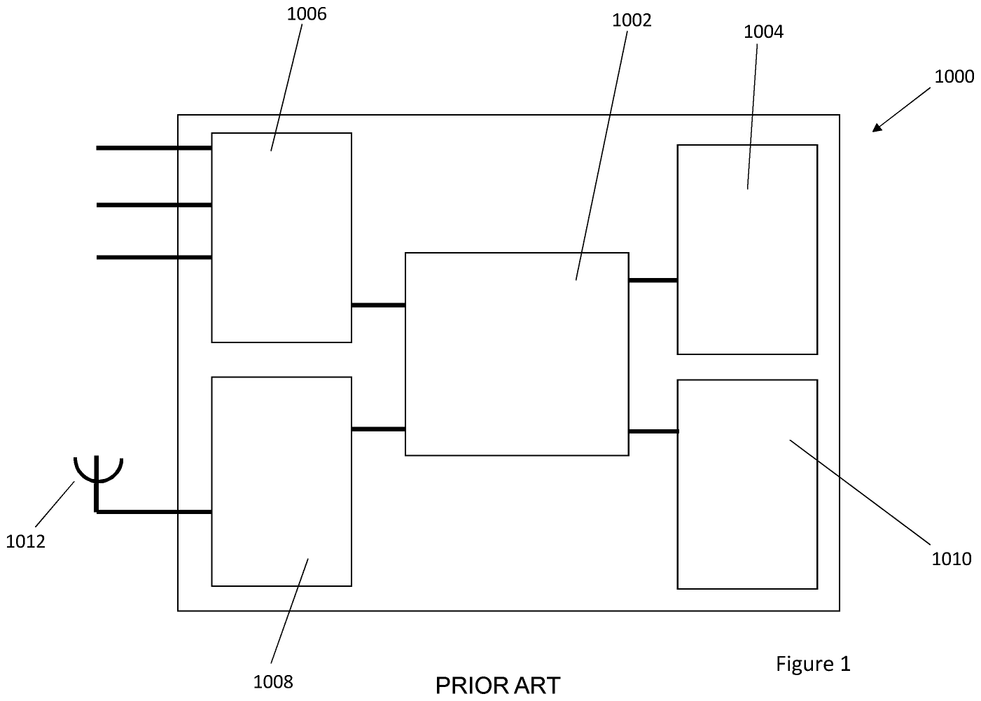

FIG. 1 is a schematic diagram of a prior art modem SoC;

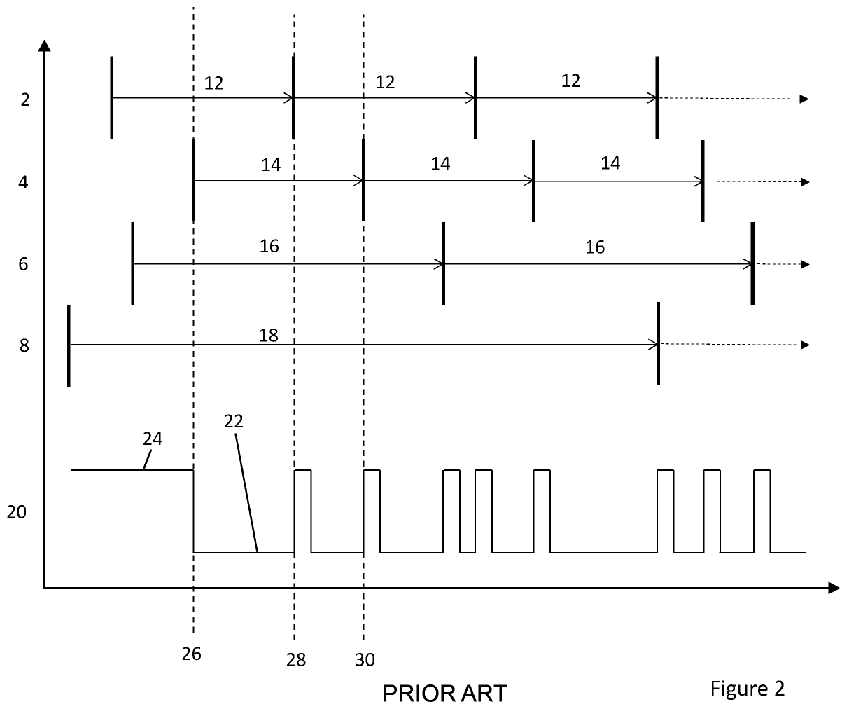

FIG. 2 is a timing diagram illustrating execution of periodic tasks in the prior art;

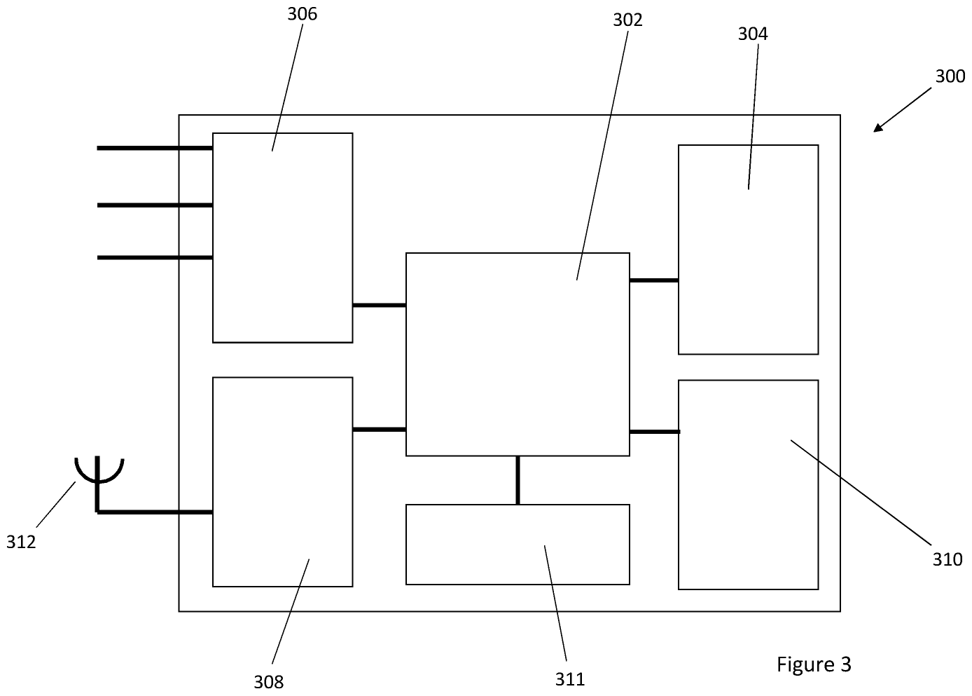

FIG. 3 is a schematic diagram of a modem SoC according to an embodiment of the present invention; and

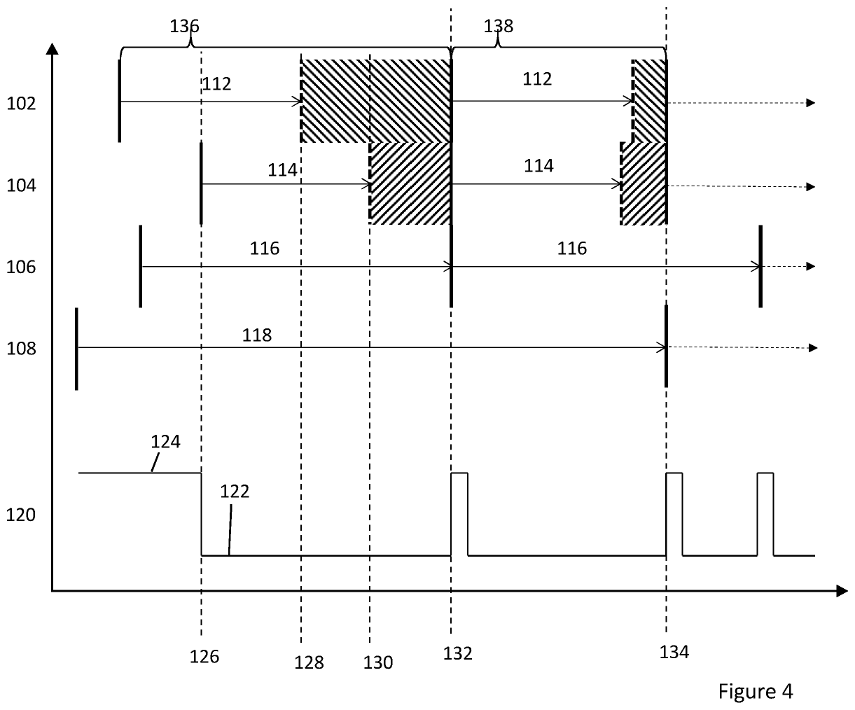

FIG. 4 is a timing diagram illustrating a method of executing periodic tasks according to the embodiment of the present invention.

FIG. 1 is a schematic diagram of a prior art modem 1000. The modem 1000 comprises a processor 1002 connected to a memory 1004, an input/output module 1006, a transceiver module 1008 and a SIM 1010.

FIG. 2 is a timing diagram showing periodic execution of first, second, third and fourth tasks 2, 4, 6, 8 with associated first, second, third and fourth execution intervals 12, 14, 16, 18 by a modem such as that illustrated in FIG. 1. These tasks are arranged to be executed on the processor 1002, whose power state 20 is either a low power sleep state 22 or a higher power awake state 24. The execution of these tasks (indicated by thick vertical lines) requires the processor 1002 to be in the higher power awake state 24.

At a sleep time 26, the processor 1002 enters into the sleep state 22. At a later time 28, the first execution interval 12 of the first task 2 has elapsed since the first task 2 was last executed. The processor 1002 is woken and enters into the awake mode 24 to execute the first task 2. This could, for example, be a routine polling of the SIM 1010. Upon completion of the first task 2, the processor 1002 enters back into the sleep state 22. At a further later time 30, the second execution interval 14 of the second task 4 has elapsed since the second task 4 was last executed, and the processor 1002 again enters into the awake mode 24, to execute the second task 4. This could, for example, be listening for data via the input/output module 1008.

This process is repeated for the third and fourth tasks 6, 8, along with further executions of the first and second tasks 2, 4. This behaviour results in many wake events, and while the processor 1002 is in the awake state 24, executing one of the tasks 2, 4, 6, 8, more power is consumed compared with that consumed in the sleep state 22.

FIG. 3 is a block diagram of a modem 300 according to an embodiment of the present invention. The modem 300 comprises a processor 302, a memory 304, an input/output module 306, a transceiver module 308, a SIM 310 and a controller module 311.

The modem 300 may be provided as part of a battery powered mobile communication device (not shown), for example a smartphone or an ‘Internet of Things’ connected smart device. In such cases the input/output module 306 provides means for communication with other elements of the device, for example a display or a sensor (not shown). It is desirable, particularly when provided as part of a battery powered device, to decrease the power demands of the modem 300 so as to increase battery life.

The modem 300 is operable to send and receive data from a network (not shown) via an antenna 312 and the transceiver module 308. Data received by the modem 300 is decoded by the processor 302 and may be sent onto other components of the device in an understandable format via the input/output module 306.

In use, the processor 302 executes various tasks. Some of these tasks require precisely periodic execution, for example controlling discontinuous reception (DRX) operation of the transceiver module 308. In such operation the processor 302 controls the transceiver module 308 to periodically receive data from the network in short prearranged time slots, and to power down between the time slots. DRX operation can reduce the power demands of the modem 300 significantly compared to continuous reception operation (where the transceiver module 308 is continually powered), however to achieve reliable and effective operation the processor 302 must issue control commands at precisely periodic intervals so that the prearranged time slots for reception are synchronised with the network.

During operation of the modem 300, the processor 302 also executes other tasks, which require periodic execution, but not at the precise intervals required by e.g. DRX operation. For example, the processor 302 must periodically poll the SIM 310 regularly to ensure valid network authentication, but it is not critical to the operation of the modem 300 for SIM polling to be precisely periodic.

In order to reduce the power used by the modem 300, the controller module 311 is arranged to control the processor 302 to enter into a lower power sleep state where one or more modules or circuits are switched off when not in use (i.e. when the processor 302 is not executing a task). There can often be long periods of time between tasks being executed, and so this measure can decrease power use significantly. Each time a task is to be executed however, the controller module 311 must wake the processor 302 into a higher power awake state and each wake event has an associated energy cost.

To further reduce power use, the modem 300 is arranged to avoid unnecessary wake events by avoiding waking the processor 302 from the lower power sleep state to execute tasks that do not need to be precisely executed, as will be explained in greater detail below with reference to FIG. 3.

FIG. 4 is a timing diagram illustrating periodic execution of first, second, third and fourth tasks 102, 104, 106, 108 by a modem according to an embodiment of the present invention such as that illustrated in FIG. 3. The first and second tasks 102, 104 have been designated as requiring only imprecisely regular execution, and have associated first and second minimum execution intervals 112, 114. For example, these tasks may comprise SIM polling or memory management tasks (e.g. filesystem sync writing modified files to flash), which may be executed at somewhat imprecise intervals without impacting the operation of the modem 300. The third and fourth tasks 106, 108, however, require precisely periodic execution, and have associated third and fourth execution intervals 116, 118. The third and fourth tasks may comprise the modem 300 initiating a DRX period or transmitting an acknowledgement message to an eNodeB. These tasks involve time critical operations such as communication with remote network elements and so require precise periodic execution to maintain synchronisation and ensure correct operation. As mentioned above, the processor 302 has a power state 120 which is either a low power sleep state 122 or a higher power awake state 124.

Starting at the left-hand end of the diagram in FIG. 3, the processor 102 is in the awake state 124 and executes, in order, the fourth, first and third tasks 108, 102, 106. It finally executes the second task 104. Thereafter, at time 126, the controller module 311 controls the processor 302 to enter into the sleep state 122.

At a later time 128 the first minimum execution interval 112 has elapsed since the first task 102 was last executed, however as the first task 102 requires only imprecisely regular execution, the first task 102 does not need to be executed immediately and the controller module 311 does not wake the processor 302 into the higher power awake state 124. At a further later time 130 the second minimum execution interval 114 has elapsed since the second task 104 was last executed, however as with the first task 102, the second task 104 requires only imprecisely regular execution and consequently the second task 104 is not executed and the controller module 311 does not wake the processor 302 into the higher power awake state 124. At an even later time 132, the third execution interval 116 has elapsed since the third task 106 was last executed, and because the third task 106 requires precisely periodic execution, the controller module 311 wakes the processor 302 into the higher power awake state 124 and the processor 302 executes the third task 106.

Since the processor 302 is now in the higher power awake state 124 after the first and second minimum execution intervals 112, 114 have elapsed, the first and second task 102, 104 are now executed using the processor 302. Once these tasks have been executed, the controller module 311 controls the processor 302 to re-enter the sleep state 122. Because the processor 302 has only been woken once to execute the first, second and third tasks 102, 104, 106, two distinct wake events with their associated power cost have been avoided. Because the first and second tasks 102, 104 require only imprecisely regular execution, the operation of the modem 300 is not affected.

As the operation of the modem 300 continues, the minimum first and second minimum execution intervals 112, 114 again elapse, and at a time 134 the fourth execution interval 118 elapses and the fourth task 108 is executed. The processor 302 is woken by the controller module 311 into the awake state 124, executes the fourth task 108 and subsequently executes the first and second tasks 102, 104.

At a final time 136, the third execution interval 116 elapses again, and the third task 106 is executed. Neither the first minimum execution interval 112 nor the second minimum execution interval 114 have elapsed and so despite the processor 302 being in the awake state 124, no further tasks are executed before the processor 302 is controlled by the controller module 311 to enter into the sleep state 122 again.

It may be noted that the actual time interval between executions of the first task 102 is not constant. A first actual execution interval 136 is greater than a second actual execution interval 138, however as explained above, because the first and second tasks 102, 104 require only imprecisely regular execution to ensure correct on-going operation of the modem 300, this irregular execution does not negatively impact the operation the modem 300.

Although in this case each minimum execution interval is measured from the latest execution of a task, in some applications the minimum execution interval may be measured from the expiry of a previous minimum execution interval. For example, if applied to the first task 102 in this case, the second occurrence of the first minimum execution interval 112 would begin at the expiry of the first occurrence of the first minimum execution interval 112 (at time 128) rather than at the execution of the first task (at time 132).

It will be appreciated by those skilled in the art that the invention has been illustrated by describing one or more specific embodiments thereof, but is not limited to these embodiments; many variations and modifications are possible, within the scope of the accompanying claims.

1. A method of operating an integrated circuit system comprising:
a processor operable in at least a lower power state and a higher power state;
a memory comprising instructions for executing a first task using the processor, the first task having a minimum execution interval associated therewith;
wherein the method comprises:
executing the first task using the processor;
after the minimum execution interval has elapsed, determining whether the processor is in the higher power state;
if the processor is in the higher power state after the minimum execution interval elapses, executing the first task using the processor; and
if the processor is not in the higher power state after the minimum execution interval elapses, not executing the first task.

2. The method of operating an integrated circuit system as claimed in claim 1, wherein the first task does not have a maximum execution interval associated with it.

3. The method of operating an integrated circuit system as claimed in claim 1, wherein the first task is only executed when the processor is in an idle state.

4. The method of operating an integrated circuit system as claimed in claim 1, wherein the first task is triggered from an idle task.

5. The method of operating an integrated circuit system as claimed in claim 1, wherein memory further comprises instructions for a second task that is executed periodically by the processor.

6. The method of operating an integrated circuit system as claimed in claim 1, wherein the memory comprises instructions for a plurality of tasks, each with an associated priority level.

7. The method of operating an integrated circuit system as claimed in claim 6, wherein each of the plurality of tasks has an associated minimum execution interval.

8. The method of operating an integrated circuit system as claimed in claim 7, wherein the method further comprises:
executing the plurality of tasks using the processor at a respective plurality of execution times;
after the executed tasks' associated minimum execution intervals have elapsed from their respective execution times, determining whether the processor is in the higher power state; and
if the processor is in the higher power state after the minimum execution intervals of a subset of the plurality of tasks have elapsed, executing the subset of the plurality of tasks in an order according to their respective associated priority level.

9. The method of operating an integrated circuit system as claimed in claim 1, wherein the processor is operable in a medium power state.

10. The method of operating an integrated circuit system as claimed in claim 9, wherein the memory further comprises instructions for executing a further task using the processor and a further minimum execution interval associated with the further task.

11. The method of operating an integrated circuit system as claimed in claim 10, wherein the further task is executable when the processor is in the medium power state or the higher power state.

12. The method of operating an integrated circuit system as claimed in claim 10 wherein the method further comprises:
executing the further task using the processor;
after the further minimum execution interval has elapsed, determining whether the processor is in the lower power state, medium power state or higher power state;
if the processor is in the medium or higher power state after the minimum execution interval elapses, executing the further task using the processor; and
if the processor is in the lower power state after the minimum execution interval elapses, not executing the further task.

13. An integrated circuit system comprising:
a processor operable in at least a lower power state and a higher power state;
a memory comprising instructions for executing a first task using the processor, the first task having a minimum execution interval associated therewith;
wherein the integrated circuit system is configured to:
execute the first task using the processor;
after the minimum execution interval has elapsed, determine whether the processor is in the higher power state;
if the processor is in the higher power state after the minimum execution interval elapses, execute the first task using the processor; and
if the processor is not in the higher power state after the minimum execution interval elapses, not execute the first task.

14. The integrated circuit system as claimed in claim 13, wherein the first task does not have a maximum execution interval associated with it

15. The integrated circuit system as claimed in claim 13, wherein the memory further comprises instructions for a second task that is executed periodically by the processor.

16. The integrated circuit system as claimed in claim 13, wherein the memory comprises instructions for a plurality of tasks, each with an associated priority level.

17. The integrated circuit system as claimed in claim 16, wherein each of the plurality of tasks has an associated minimum execution interval.

18. The integrated circuit system as claimed in claim 17, wherein the integrated circuit system is further configured to:
execute the plurality of tasks using the processor at a respective plurality of execution times;
after the executed tasks' associated minimum execution intervals have elapsed from their respective execution times, determine whether the processor is in the higher power state; and
if the processor is in the higher power state after the minimum execution intervals of a subset of the plurality of tasks have elapsed, execute the subset of the plurality of tasks in an order according to their respective associated priority level.

19. The integrated circuit system as claimed in claim 13, wherein the processor is operable in a medium power state.

20. The integrated circuit system as claimed in claim 19, wherein the memory further comprises instructions for executing a further task using the processor and a further minimum execution interval associated with the further task.

21. The integrated circuit system as claimed in claim 20, wherein the further task is executable when the processor is in the medium power state or the higher power state.

22. The integrated circuit system as claimed in claim 20 wherein the integrated circuit system is further configured to:
execute the further task using the processor;
after the further minimum execution interval has elapsed, determine whether the processor is in the lower power state, medium power state or higher power state;
if the processor is in the medium or higher power state after the minimum execution interval elapses, execute the further task using the processor; and
if the processor is in the lower power state after the minimum execution interval elapses, not execute the further task.
